(19) United States
(12) Patent Application Publication
(10) Pub. No.: US 2017/0169460 A1
(43) Pub. Date: Jun. 15, 2017

(54) MEASURING PERFORMANCE OF CONTENT PRESENTED ON AN ONLINE SYSTEM BASED ON USER INFORMATION RECEIVED AT VARIABLE RATES

(71) Applicant: Facebook, Inc., Menlo Park, CA (US)

(72) Inventors: Alexandra Louise Krakaris, Orinda, CA (US); Konrad Komorowski, London (GB); Benjamin Tucker Savage, London (GB); Rotem Druker, London (GB)

(21) Appl. No.: 14/970,209

(22) Filed: Dec. 15, 2015

(51) Int. Cl. G06Q 30/02; H04W 4/02; H04L 29/08

(52) U.S. Cl. CPC G06Q 30/0242; H04L 67/18; H04W 4/021; H04L 67/1044

(57) ABSTRACT

An online system receives information from client devices describing locations of online system users and identifies certain events based on the information. To account for different rates at which information is received from client devices when identifying events, the online system identifies a group of users associated with location information received at greater than a threshold rate and an alternative group of users associated with information received at less than the threshold rate. Based on a value associated with the group and an additional value associated with the alternative group, the online system computes a scaling factor that is applied to the additional value, allowing the online system to account for potential events associated with the alternative group that were not identified because of the lower rate at which the online system received location information associated with users in the additional group.

### BACKGROUND

This disclosure relates generally to online systems, and more specifically to presenting content to online system users.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. Content provided to an online system by a user may be declarative information provided by a user, status updates, check-ins to locations, images, photographs, videos, text data, or any other information a user wishes to share with additional users of the online system. An online system may also generate content for presentation to a user, such as content describing actions taken by other users on the online system.

Additionally, many online systems commonly allow users (e.g., businesses) to sponsor presentation of content on an online system to gain public attention for a user's products or services or to persuade other users to take an action regarding the user's products or services. Content for which the online system receives compensation in exchange for presenting to users is referred to as “sponsored content.” Many online systems receive compensation from a user for presenting online system users with certain types of sponsored content provided by the user. Frequently, online systems charge a user for each presentation of sponsored content to an online system user or for each interaction with sponsored content by an online system user. For example, an online system receives compensation from an entity each time a content item provided by the user is displayed to another user on the online system or each time another user is presented with a content item on the online system and interacts with the content item (e.g., selects a link included in the content item), or each time another user performs another action after being presented with the content item (e.g., visits a physical location associated with the user who provided the content item).

Users who provide compensation to an online system in exchange for presenting sponsored content to other users often expend significant resources promoting their products, services, or brands via the online system. Accordingly, users compensating the online system for presenting sponsored content often seek to determine the effectiveness of presenting sponsored content items via the online system at influencing online system users to perform certain actions after being presented with the sponsored content items. For example, a user determines an effectiveness of a sponsored content item presented via an online system at inducing online system users to visit various physical locations associated with the user, such as a retail store. As another example, a user measures a sponsored content item's effectiveness at influencing online system users to perform various actions, such as purchasing products or services at a physical location, after being presented with the sponsored content item.

To measure a content item's effectiveness in inducing certain actions by users, a user providing the content item often polls online system users to determine whether various users have been presented with the content item or whether the user performed one or more actions after being presented with the content item (e.g., visited a specific physical location performed a particular action at a physical location). Based on responses to polls by various users, the user providing the content item may determine an effectiveness of the content item in inducing actions by users. However, responses to polls are often unreliable as online system users often have limited recall of how they became aware of various products or services or identifying a particular reason for performing one or more actions.

An online system providing content to users in exchange for compensation from a user may provide the user with one or more metrics describing actions performed by other users of the online system after being presented with sponsored content from the user. In various circumstances, the online system determines one or more of the metrics based on information associated with users by the online system identifying physical locations associated with one or more users of the online system. A client device associated with an online system user may execute an application associated with the online system communicating information identifying a physical location of the client device to the online system, which stores the physical location of the client device in association with a user corresponding to the client device. For example, an online system presents a user with a content item and, based on received information identifying a physical location of a client device associated with the user, maintains a number of times the user visits a specific location associated with the content item during a particular time interval. Based on the number of times the user visited the specific location after being presented with the content item, the online system determines a metric that is provided to a user associated with the content item, allowing the user to more accurately evaluate the content item's effectiveness.

However, the online system may receive location information of client devices associated with different users at different rates. For example, certain client devices executing an application associated with the online system provide location information to the online system more frequently than other client devices executing the application associated with the online system. The frequency with which a client device executing the application associated with the online system provides location information to the online system may be based on one or more settings specified by a user associated with the client device. Receiving location information from different client devices at different rates may reduce the accuracy of certain metrics determined by the online system. For example, if the online system measures a number of times a user visits a specific location after being presented with a particular content item, the measurement may be inaccurately low if a client device associated with the client device infrequently communicates location information to the online system, as the user may visit the location during intervals when the client device does not communicate location information to the online system. Accordingly, conventional online systems may inaccurately determine metrics describing performance of various content items based on variable rates at which the online system receives certain information associated with users.

### SUMMARY

An online system generates one or more metrics to describe effectiveness of content items presented to online system users inducing one or more actions by the online system based on location information associated with online system users received by the online system. The online system receives location information from client devices executing an application associated with the online system, where location information received from a client device identifies a physical location of the client device. Based on associations between client devices and users, the online system associates location information received from a client device with a user corresponding to the client device. Based on location information received from a client device and associated with a user corresponding to the client device, the online system determines whether the user has performed one or more actions based on a physical location identified by the location information. For example, based on a physical location associated with location information received from a client device, the online system determines whether the user is within a threshold distance of a specified physical location. Based on whether the user is within the threshold distance of the specified physical location, the online system determines whether the user performed one or more actions.

In various embodiments, the online system determines whether one or more conversion events, or “conversions,” were performed by a user based on whether a physical location associated with a user is within a threshold distance of a specified physical location. A conversion is an occurrence of one or more particular actions by a user within a threshold distance of a specified physical location. Examples of conversions include a physical location associated with the user being within a threshold distance of the specified physical location or a user performing a specific action while a physical location associated with the user is within a threshold distance of the specified physical location.

The online system computes a metric describing a content item's influence on user actions based in part on an identified number of conversions performed by one or more groups of users. For example, the online system determines a difference between a number of conversions performed by users who were presented with an advertisement and an additional number of conversions performed by users who were not presented with the advertisement. The determined difference provides a measure of the advertisement's effectiveness in inciting users to perform conversions In some embodiments, the online system determines a metric based on a number of users associated with physical locations within a threshold distance of a specific physical location during a time interval or a number of times a user is associated with a physical location within the threshold distance of the specific physical location during the time interval. For example, the online system identifies a conversion when the online system receives location information indicating a user's physical location is within a threshold distance of a physical location associated with a store that is associated with an advertisement presented by the online system. As another example, the online system identifies a conversion when the online system receives location information and a user identifier from a third party system (e.g., via a point of sale terminal) associated with a specific physical location and also associated with an advertisement presented by the online system. Hence, the generated metric may describe an advertisement's (or other content item's) effectiveness at inducing online system users to visit specific physical locations based on conversions identified by the online system.

However, the online system may receive location information from different client devices at different rates, affecting identification of conversions the online system. For example, some client devices communicate location information to the online system less frequently than other client devices. Different users may maintain different settings on different client devices that modify rates at which the client devices communicate location information to the online system. As an example, certain settings maintained by an application executing on a client device cause the client device to communicate location information to the online system at greater than a threshold rate (e.g., continuously), while other settings cause the client device to communicate location information to the online system at less than the threshold rate. One or more settings of an application associated with the online system that executes on a client device may limit the client device to communicating location information to the online system when the client device has certain types of connections to a network (e.g., BLUETOOTH®, 802.11, global positioning system) and not when the client device has other types of connections to the network (e.g., cellular), which affects a rate at which the client device communicates location information to the online system. This variability in frequency of receiving location information may reduce the accuracy of the number of conversions identified by the online system, reducing an accurate of one or more metrics determined by the online system that describe effectiveness of content items presented to users inducing user actions.

To account for different rates at which the online system receives location information from different client devices, which allows more accurate identification of conversions, the online system identifies a group of users associated with location information received from client devices at greater than a threshold rate and an alternative group of users associated with location information received from client devices at less than the threshold rate. Based on the number of users in the group and alternative group and on the identified number of conversions associated with users in the group and in the alternative group, the online system computes a scaling factor, which is applied to a value associated with the alternative group. For example, the value associated with the alternative group is a number of conversions associated with the alternative group. Applying the scaling factor to the identified number of conversions associated with users in the alternative group determines an estimated number of conversions associated with the alternative group accounting for conversions from users in the alternative group that were not identified because of the lower rate at which the online system receives location information from client devices associated with users in the alternative group. For example, the online system multiplies the identified number of conversions associated with the alternative group by the scaling factor to produce an estimated number of conversions.

The scaling factor may be based in part on conversion rates associated with the group and alternative group. A conversion rate associated with the group is a ratio of a number of conversions identified for users in the group to a number of users in the group. Similarly, a conversion rate associated with the alternative group is a ratio of a number of conversions identified for users in the alternative group to a number of users in the alternative group. In one embodiment, the scaling factor is a ratio of the conversion rate associated with the group to the conversion rate associated with the alternative group. In other embodiments, the scaling factor is based on a frequency by which the online system receives location information associated with users in the group and alternative group. For example, the scaling factor is a ratio of a rate at which the online system receives location information from client devices associated with users in the group to a ratio of a rate at which the online system receives location information from client devices associated with users in the alternative group.

In some embodiments, the online system identifies subgroups of the group and of the alternative group and computes scaling factors for different subgroups of the alternative group. For example, a subgroup of the group or of the alternative group includes users having at least a threshold number or percentage of common characteristics, users presented with a specific content item, users not presented with a specific content item, or users satisfying any other suitable criteria. In other examples, a subgroup includes users associated with client devices from which location information was received via a specific type of network connection, users who performed a specific action, users connected to a specific object via the online system, or users having any other suitable common characteristic. In some embodiments, the online system determines a scaling factor for a subgroup of the alternative group based on a number of conversions associated with the subgroup of the alternative group, a number of users in the subgroup of the alternative group, a number of conversions associated with a subgroup of the group having characteristics matching the subgroup of the alternative group, and a number of users in the subgroup of the group. The online system applies the scaling factors to a number of conversions or to rate of conversions associated with the subgroup of the alternative group to more accurately identify conversions performed by users in the subgroup of the alternative group.

Based on a number of conversions associated with the group and an estimated number of conversions associated with the alternative group, determined by applying the scaling factor to the identified number of conversions associated with the alternative group, the online system generates the metric describing effectiveness of one or more continent items in inciting users to perform one or more actions. For example, the online system estimates a number of conversions occurring in a set of users eligible to receive an advertisement by combining the estimated number of conversions associated with the alternative group to the identified number of conversions associated with the group. In various embodiments, the online system combines an estimated number of conversions associated with a subgroup of the alternative group with an identified number of conversions associated with a subgroup of the group having at least a threshold similarity to the subgroup of the additional group. In some embodiments, the online system determines the metric as a difference between a number of conversions associated with a group of users that were presented with the advertisement and a group of users that were not presented with the advertisement. Hence, accounting for differences in rates at which the online system receives location information from client devices allows the online system to more accurately determine a metric describing effectiveness of one or more content items at influencing online system users to perform one or more actions.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for determining effectiveness of content presented on an online system causing user action based on user location information received from client devices at different rates, in accordance with an embodiment.

FIG. 4A is an example of data describing identified effectiveness of content presented on an online system in inducing actions based on user location information received by the online system from client devices at different rates, in accordance with an embodiment.

FIG. 4B is an example of scaling factors computed by the online system, in accordance with an embodiment.

FIG. 4C is an example of data describing effectiveness of content presented on an online system in inducing actions by users based on one or more scaling factors determined by the online system and actions identified by the online system, in accordance with an embodiment.

FIG. 4D is an example of data describing effectiveness of content presented on an online system in inducing actions by users based on one or more scaling factors for subgroups of users determined by the online system and actions identified by the online system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

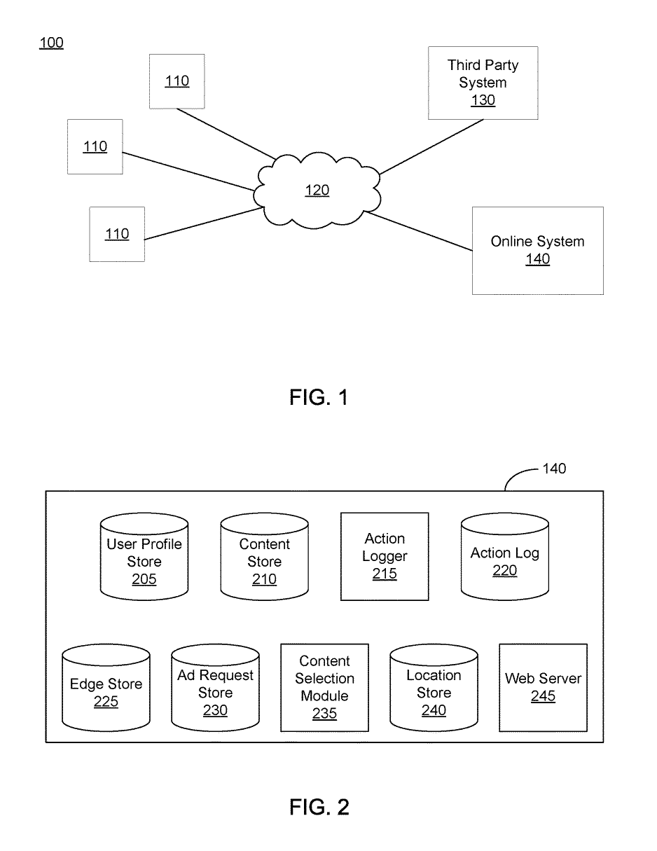

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The embodiments described herein may be adapted to online systems that are social networking systems, content sharing networks, or other systems providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

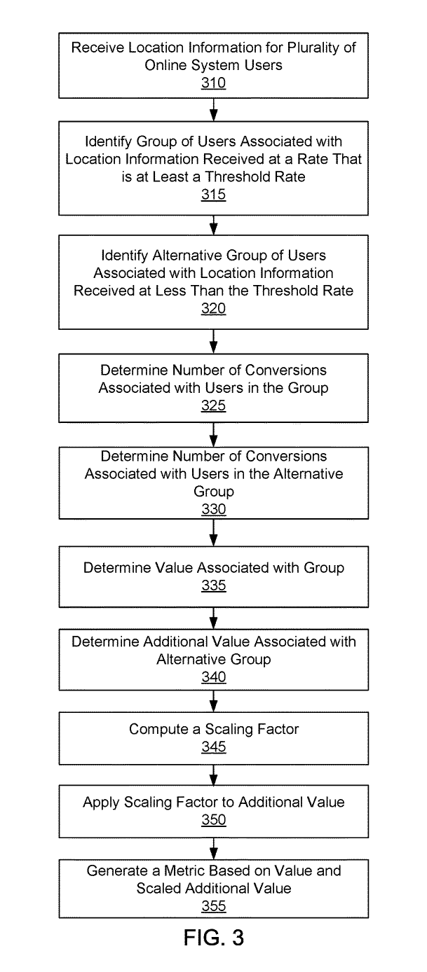

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 may also communicate information to the online system 140, such as advertisements, content, or information about an application provided by the third party system 130.

In some embodiments, one or more of the third party systems 130 provide content to the online system 140 for presentation to users of the online system 140 and provide compensation to the online system 140 in exchange for presenting the content. For example, a third party system 130 provides advertisement requests, which are further described below in conjunction with FIG. 2, including advertisements for presentation and amounts of compensation provided by the third party system 130 to the online system 140 in exchange presenting the advertisements to the online system 140. Content presented by the online system 140 for which the online system 140 receives compensation in exchange for presenting is referred to herein as “sponsored content.” Sponsored content from a third party system 130 may be associated with the third party system 130 or with another entity on whose behalf the third party system 130 operates.

FIG. 2 is a block diagram of an architecture of the online system 140. The online system 140 shown in FIG. 2 includes a user profile store 205, a content store 210, an action logger 215, an action log 220, an edge store 225, an advertisement (“ad”) request store 230, a content selection module 235, a location store 240, and a web server 245. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity. In some embodiments, the brand page associated with the entity's user profile may retrieve information from one or more user profiles associated with users who have interacted with the brand page or with other content associated with the entity, allowing the brand page to include information personalized to a user when presented to the user.

The content store 210 stores objects that each represents various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), engaging in a transaction, viewing an object (e.g., a content item), and sharing an object (e.g., a content item) with another user. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or a particular user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An ad request includes advertisement content, also referred to as an “advertisement,” and a bid amount. The advertisement is text, image, audio, video, or any other suitable data presented to a user. In various embodiments, the advertisement also includes a landing page specifying a network address to which a user is directed when the advertisement content is accessed. The bid amount is associated with an ad request by an advertiser and is used to determine an expected value, such as monetary compensation, provided by the advertiser to the online system 140 if an advertisement in the ad request is presented to a user, if the advertisement in the ad request receives a user interaction when presented, or if any suitable condition is satisfied when the advertisement in the ad request is presented to a user. For example, the bid amount specifies a monetary amount that the online system 140 receives from the advertiser if an advertisement in an ad request is displayed. In some embodiments, the expected value to the online system 140 of presenting the advertisement may be determined by multiplying the bid amount by a probability of the advertisement being accessed by a user.

Additionally, an ad request may include one or more targeting criteria specified by the advertiser. Targeting criteria included in an ad request specify one or more characteristics of users eligible to be presented with advertisement content in the ad request. For example, targeting criteria are used to identify users having user profile information, edges, or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users who have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows advertisers to further refine users eligible to be presented with advertisement content from an ad request. As another example, targeting criteria identifies users having a connection to another user or object or having a particular type of connection to another user or object.

The content selection module 235 selects one or more content items for communication to a client device 110 to be presented to a user. Content items eligible for presentation to the user are retrieved from the content store 210, from the ad request store 230, or from another source by the content selection module 235, which selects one or more of the content items for presentation to the user. A content item eligible for presentation to the user is a content item associated with at least a threshold number of targeting criteria satisfied by characteristics of the user or is a content item that is not associated with targeting criteria. In various embodiments, the content selection module 235 includes content items eligible for presentation to the user in one or more selection processes, which identify a set of content items for presentation to the user. For example, the content selection module 235 determines measures of relevance of various content items to the user based on characteristics associated with the user by the online system 140 and based on the user's affinity for different content items. Information associated with the user included in the user profile store 205, in the action log 220, and in the edge store 225 may be used to determine the measures of relevance. Based on the measures of relevance, the content selection module 235 selects content items for presentation to the user. As an additional example, the content selection module 235 selects content items having the highest measures of relevance or having at least a threshold measure of relevance for presentation to the user. Alternatively, the content selection module 235 ranks content items based on their associated measures of relevance and selects content items having the highest positions in the ranking or having at least a threshold position in the ranking for presentation to the user.

Content items selected for presentation to the user may include advertisements from ad requests or other content items associated with bid amounts. The content selection module 235 uses the bid amounts associated with ad requests when selecting content for presentation to the viewing user. In various embodiments, the content selection module 235 determines an expected value associated with various ad requests (or other content items) based on their bid amounts and selects advertisements from ad requests associated with a maximum expected value or associated with at least a threshold expected value for presentation. An expected value associated with an ad request or with a content item represents an expected amount of compensation to the online system 140 for presenting an advertisement from the ad request or for presenting the content item. For example, the expected value associated with an ad request is a product of the ad request's bid amount and a likelihood of the user interacting with the ad content from the ad request. The content selection module 235 may rank ad requests based on their associated bid amounts and select advertisements from ad requests having at least a threshold position in the ranking for presentation to the user. In some embodiments, the content selection module 235 ranks both content items not associated with bid amounts and ad requests in a unified ranking based on bid amounts associated with ad requests and measures of relevance associated with content items and with ad requests. Based on the unified ranking, the content selection module 235 selects content for presentation to the user. Selecting ad requests and other content items through a unified ranking is further described in U.S. patent application Ser. No. 13/545,266, filed on Jul. 10, 2012, which is hereby incorporated by reference in its entirety.

For example, the content selection module 235 receives a request to present a feed of content (also referred to as a “content feed”) to a user of the online system 140. The feed may include one or more advertisements as well as content items, such as stories describing actions associated with other online system users connected to the user. The content selection module 235 accesses one or more of the user profile store 205, the content store 210, the action log 220, and the edge store 225 to retrieve information about the user and selects content items based on the retrieved information. For example, information describing actions associated with other users connected to the user or other data associated with users connected to the user is retrieved and used to select content items describing actions associated with one or more of the other users. Additionally, one or more ad requests may be retrieved from the ad request store 230. The retrieved ad requests and other content items are analyzed by the content selection module 235 to identify candidate content items that are likely to be relevant to the user. For example, content items associated with users who not connected to the user or content items associated with users for whom the user has less than a threshold affinity are discarded as candidate content items. Based on various criteria, the content selection module 235 selects one or more of the candidate content items or ad requests identified as candidate content items for presentation to the user. The selected content items or advertisements from selected ad requests are included in a feed of content that is presented to the user. For example, the feed of content includes at least a threshold number of content items describing actions associated with users connected to the user via the online system 140.

In various embodiments, the content selection module 235 presents content to a user through a feed including a plurality of content items selected for presentation to the user. One or more advertisements may also be included in the feed. The content selection module 235 may also determine an order in which selected content items or advertisements are presented via the feed. For example, the content selection module 235 orders content items or advertisements in the feed based on likelihoods of the user interacting with various content items or advertisements.

The location store 240 stores location information describing physical locations of users of the online system 140. In various embodiments, the location information stored in the location store 240 identifies an online system user and includes location information received from a client device 110 associated with the online system user. For example, the online system 140 receives location information describing a current physical location of a client device 110 associated with a user and executing an application associated with the online system 140 and stores the received location information in the location store 240 in association with information identifying the user. Location information may be communicated by a client device 110 to the online system 140 when the client device 110 is within a threshold distance of a specified location, at periodic time intervals, or when any other suitable condition is satisfied. Hence, the client device 110 communicates updated location information to the online system 140 when conditions are satisfied, allowing the online system 140 to maintain current location information for a user associated with the client device 110. In various embodiments, the online system 140 receives updated location information from a client device 110 and stores the updated location information in the location store 240 in association with a user corresponding to the client device 110. The online system 140 may maintain previously stored location information received from the client device 110 when the updated location information is received or may remove previously stored location information and store the updated location information in various embodiments. For example, the online system 140 receives updated location information in response to a change in the location of a client device 110 associated with an online system user and stores the updated location information in the location store 240 along with location information previously received from the client device 110 within a particular time interval.

In some embodiments, location information associated with a user of the online system 140 is received from a third party system 130 along with information identifying the user of the online system 140. For example, the online system 140 receives location information from a third party system 130 identifying a physical location associated with the third party system 130 and identifying a user of the online system 140 and stores the identified physical location in the location store 240 in association with information identifying the identified user. The third party system 130 may receive information identifying the user from a device (e.g., a point of sale terminal used by the user to complete a financial transaction at the location) associated with or included in a physical location associated with the third party system 130.

The location store 240 also stores location information identifying physical locations corresponding to conversions (“conversion locations”) associated with content items (e.g., advertisements) or physical locations corresponding to a user who provided a content item to the online system 140. A conversion is an occurrence of one or more particular actions by a user within an identified physical location associated with a content item. In various embodiments, a user providing an ad request to the online system 140 (or a user associated with the ad request) identifies one or more actions for a conversion and one or more physical locations associated with one or more of the actions. For example, the location store 240 retrieves and stores information from an ad request identifying physical locations of retail stores, buildings, or other locations associated with a product or a service identified in the ad request or associated with a user associated with the ad request. In other embodiments, information identifying a conversion location is obtained by the online system 140 separate from the ad request and includes information identifying the ad request associated with the conversion location.

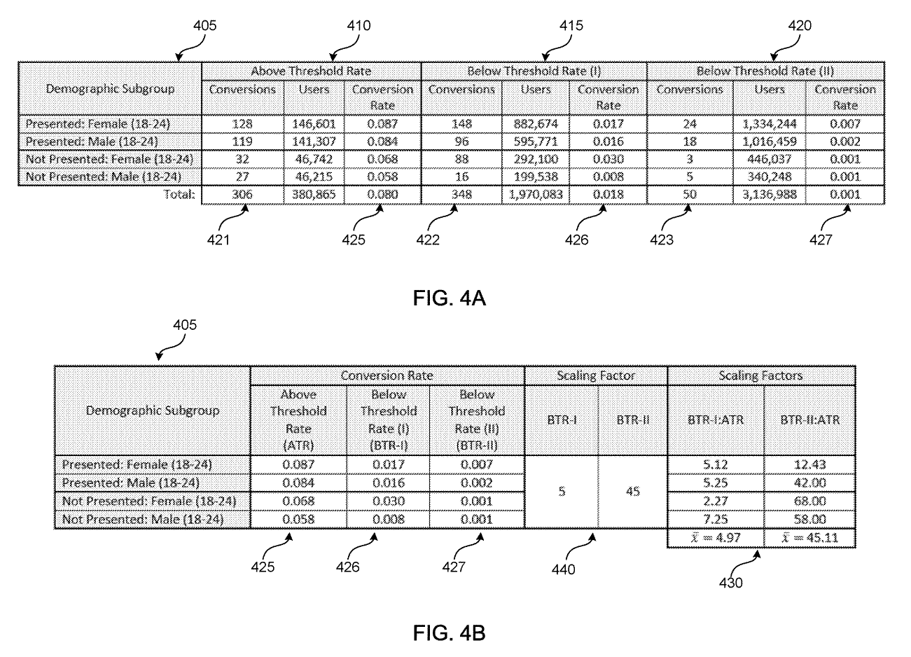

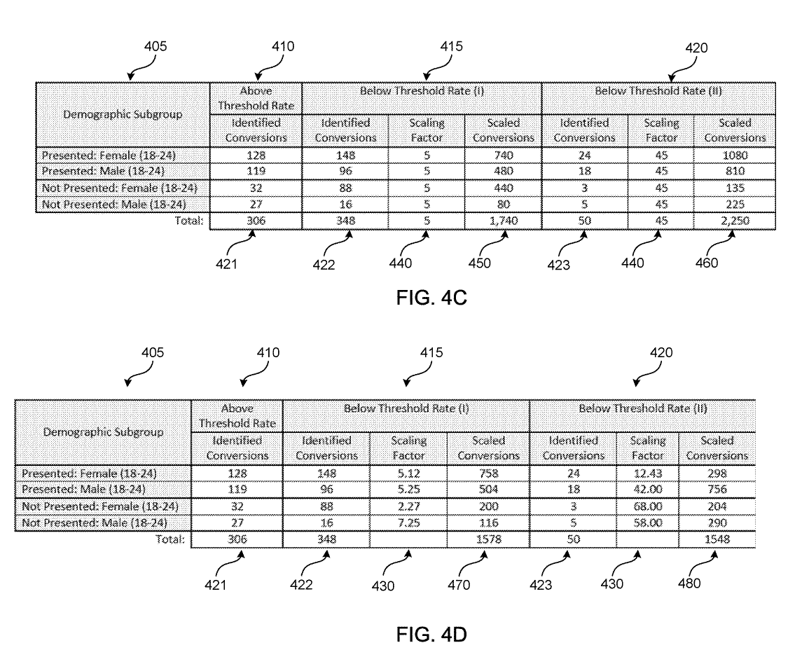

Location information describing locations of online system users or of conversion locations include geographic coordinates, place identifiers (e.g., store name, street address, etc.), or other information suitable for identifying a physical location. In some embodiments, location information stored in the location store 240 also includes various attributes of the locations, such as types of connections to a network 120 (e.g., BLUETOOTH®, 802.11, global positioning system, etc.) available from a location, identifiers of wireless access points within a threshold distance of the location, identifiers of cellular phone towers within a threshold distance of the location, or other suitable information. For example, location information describing a conversion location includes a type of network connection available at the location for transmitting information from a client device 110 to the online system 140. As further described below in conjunction with FIGS. 3-4D, the content selection module 235 may determine effectiveness of presenting various content items to users in inducing actions (e.g., conversions) by the users.

The web server 245 links the online system 140 via the network 120 to the one or more client devices 110, as well as to the one or more third party systems 130. The web server 245 serves web pages, as well as other content, such as JAVA®, FLASH®, XML and so forth. The web server 245 may receive and route messages between the online system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that are stored in the content store 210. Additionally, the web server 245 may provide application programming interface (API) functionality to send data directly to native client device operating systems, such as IOS®, ANDROID™, WEBOS® or BlackberryOS.

### Determining Effectiveness of Content Items in Inducing User Action Based on Location Information

FIG. 3 is a flowchart of one embodiment of a method for measuring effectiveness of content presented by an online system 140 in causing one or more user actions based on location information received by the online system 140 from various client devices 110. In other embodiments, the method may include different and/or additional steps than those shown in FIG. 3. Additionally, steps of the method may be performed in different orders than the order described in conjunction with FIG. 3 in various embodiments.

The online system 140 receives 310 location information from a plurality of client devices 110 each associated with an online system user. Location information received 310 from a client device 110 identifies a physical location of an online system user, and the online system 140 associates the location information from the client device 110 with the online system user associated with the client device 110. As further described above in conjunction with FIG. 2, location information is information suitable for identifying a physical location. For example, location information includes one or more geographic coordinates a location identifier, such as a street address. In some embodiments, location information received 310 by the online system 140 identifies a current physical location and one or more physical locations associated with the client device 110 at one or more prior times. For example, location information received 310 by the online system 140 identifies a current location of a client device 110 associated with a user as well as one or more prior locations associated with the client device 110 within a particular time interval.

In some embodiments, the online system 140 receives 310 location information from client devices 110 executing an application associated with the online system 140, which communicates the location information and information identifying the client device 110 or identifying a user of the online system 140 to the online system 140. A client device 110 may communicate location information to the online system 140 at periodic time intervals or when one or more conditions are satisfied. For example, the online system 140 receives 310 location information from a client device 110 executing an application associated with the online system 140 when the client device 110 is within a threshold distance of a specific location, such as a location identified by an ad request stored by the online system 140. As a specific example, the online system 140 receives 310 location information from a client device 110 associated with an online system user when the client device 110 is within a threshold distance of a retail store identified in an ad request submitted to the online system 140 by an entity associated with the retail store. As another example, the online system 140 receives 310 location information from a client device 110 when the client device 110 is within a threshold distance of certain devices for connecting to a network 120 (e.g., wireless access points or cellular phone towers). In other embodiments, the online system 140 receives 310 location information from a client device 110 executing an application associated with the online system 140 at hourly intervals or at some other specified time interval. Alternatively, the online system 140 receives 310 location information from a client device executing an application associated with the online system 140 when a physical location of the client device 110 changes.

In some embodiments, the online system 140 receives 310 location information from a third party system 130 along with information identifying a user of the online system 140. For example, the online system 140 receives 310 location information from a third party system 130 identifying a physical location associated with the third party system 130 along with information identifying a user of the online system 140 and associates the location information with the user. The location information and information identifying the user of the online system 140 may be communicated to the online system 140 by a device associated with the third party system 130, such as a point of sale terminal used by the user to engage in a financial transaction at a physical location corresponding to the location information or may be obtained from the device by the third party system 130, which communicates the location information and information identifying the user to the online system 140.

The online system 140 may receive 310 location information from different client devices 110 at different rates. For example, some client devices 110 communicate location information to the online system 140 more frequently than other client devices 110. Different client devices 110 may have different user-specified settings regulating frequencies with which applications executing on the client devices 110 and associated with the online system 140 communicate location information to the online system 140. Hence, certain client devices 110 communicate location information to the online system 140 at greater than a threshold rate (e.g., location information is continuously communicated to the online system 140 while the client device 110 is connected to a network 120 coupled to the online system 140), while other client devices 110 communicate location information to the online system 140 at less than the threshold rate (e.g., location information is reported to the online system 140 when a user checks-in at a location via the client device 110 or when the client device has one or more particular types of connection to a network 120 coupled to the online system 140).

Similarly, different third party systems 130 may communicate location information and information identifying online system users to the online system 140 at different rates. Hence, some third party systems 130 more frequently communicate location information and information identifying online system users to the online system 140 than other third party systems 130. For example, some third party systems 130 communicate location information and information identifying online system users to the online system 140 at daily or hourly intervals, while other third party systems 130 communicate location information and information identifying online system users to the online system 140 less frequently (e.g., every other day or every other hour).

The online system identifies 315 a group of users associated with location information received 310 from client devices 110 at rates equaling or exceeding a threshold rate and also identifies 320 an alternative group of users associated with location information received 310 from client devices 110 at rates less than the threshold rate. In some embodiments, the threshold rate is based on a number or a percentage of times the online system 140 receives 310 location information from a client device 110 associated with a user within a specified period of time. For example, the online system 140 identifies 315 a group of users associated with location information received 310 by the online system 140 at least eighty percent of the time an application associated with the online system 140 executes on client devices 110 associated with users in the group and identifies 320 an alternative group of users associated with location information received 310 by the online system 140 less than eighty percent of the time the application associated with the online system 140 executes on client devices 110 associated with users in the alternative group. As another example, the online system 140 identifies 315 a group of users associated with client devices 110 that communicate location information to the online system 140 at least ninety-five percent of the time the client devices 110 are connected to a network 120 coupled to the online system 140 and identifies 320 an alternative group of users associated with client devices 110 that communicate location information to the online system less than ninety-five percent of the time the client devices 110 are connected to a network coupled to the online system 140. In another example, the online system 140 identifies 315 a group of users associated with client devices 110 that continuously communicate location information to the online system 140 and identifies 320 an alternative group of users associated with client devices 110 that less than continuously communicate location information to the online system 140. Referring to the example of FIG. 4A, the online system 140 identifies 315 a group 410 of 380,865 online system users for whom the online system 140 receives 310 location information from client devices 110 associated with the users at rates greater than a threshold rate and identifies 320 an alternative group 415 of 1,970,083 users for whom the online system 140 receives 320 location information from client devices 110 associated with the users at rates less than the threshold rate.

In other embodiments, the online system 140 identifies 315 a group of users associated with location information received 310 from a third party system 130 rates that are at least a threshold rate and identifies 320 an alternative group of users associated with location information received from a third party system 130 at rates that are less than the threshold rate. For example, the online system 140 identifies 315 a group 410 of users associated with location information received 310 from a third party system 130 that communicates location information to the online system 140 greater than twenty-seven days per month and identifies 320 an alternative group of users associated with location information received from a third party system 130 that communicates location information to the online system 140 not more than twenty-seven days per month. In other embodiments, location information and information identifying online system users associated with location information may be received 310 from any suitable source, and the online system 140 identifies 315 a group of users associated with location information received 310 from one or more sources at rates that equal or exceed the threshold rate and identifies 320 an alternative group of users associated with location information received 310 from one or more sources at rates less than the threshold rate.

In some embodiments, the online system 140 identifies one or more subgroups of users from the identified group and from the identified alternative group. Users in a subgroup at least a threshold number or percentage of common characteristics. Examples of common characteristics include demographic attributes, presentation of particular content item to the users, lack of presentation of the particular content item to the users, a connection to a particular object, performance of one or more specific actions, receipt of location information by the online system 140 from client devices 110 having a particular type of connection to a network 120 or any other suitable criteria. In the example of FIG. 4A, the online system 140 identifies four subgroups 405 of users in the identified group 410 and in the identified alternative group 415. The subgroups 405 identified in the example of FIG. 4 include: online system users who are female users between the ages of eighteen and twenty four who were presented with an advertisement via the online system 140, f online system users who are male users between the ages of eighteen and twenty four that who presented with the advertisement via the online system 140, online system users who are female users between the ages of eighteen and twenty four who were not presented with the advertisement via the online system 140, and online system users who are male users between the ages of eighteen and twenty four who were not presented with the advertisement via the online system 140. Hence, each subgroup 405 includes users having at least a threshold number or a threshold percentage of characteristics in common with each other, as described above.

In various embodiments, the online system 140 also identifies one or more additional alternative groups of users associated with location information received 310 from client devices 110 at different rates. For example, the online system 140 identifies 320 the alternative group of users associated with location information received 310 from client devices 110 communicating location information to the online system 140 at rates less than a threshold rate and also identifies an additional alternative group of users associated with location information received 310 from client devices 110 communicating location information to the online system 140 at rates less than an additional threshold rate. In the example of FIG. 4A, the online system identifies 320 the alternative group 415 of users associated with location information received from client devices 110 less than continuously and also identifies an additional alternative group 420 of users for whom location information is not received. The additional alternative group 420 identified in FIG. 4A includes 3,136,988 online system users for whom the online system 140 does not receive location information. As another example, the online system 140 identifies 320 an alternative group 415 of users associated with client devices 110 that report location information to the online system 140 less than ninety-five percent of the time the client devices 110 are connected to a network 120 coupled to the online system 140 and identifies an additional alternative group of users associated with client devices 110 that report location information to the online system 140 less than eighty percent of the time the client devices 110 are connected to a network 120 coupled to the online system 140.

In some embodiments, the additional alternative group of users is identified based on similarity of users rather than a rate at which location information is received 310 by the online system 140 from client devices 110 associated with the users. For example, the additional alternative group includes users for whom the online system 140 receives location information at less than the threshold rate and where the location information is received 310 via a specific type of connection between client devices 110 and a network 120 (e.g., BLUETOOTH®, 802.11, global positioning system, etc.). As another example, the online system 140 identifies 320 the alternative group as users associated with client devices 110 from which location information is received 310 from client devices 110 at less than the threshold rate and identifies the additional alternative group as users associated with location information received from a third party system 130. In another example, the additional alternative group includes users associated with one or more specific actions performed at a physical location(e.g., a transaction by credit card, a transaction by cash, etc.) and associated with client devices 110 from which the online system 140 receives location information at less than the threshold rate (or at less than an additional threshold rate). Additionally, the online system 140 may identify one or more subgroups of users having at least a threshold number or a threshold percentage of common characteristics from the additional alternative group, as further described above.

Based on location information associated with users in the group and associated with users in the alternative group, the online system 140 identifies occurrences of one or more events (also referred to as “conversions” or “conversion events”) associated with users in the group and associated with users in the alternative group. A conversion is an occurrence of one or more specified actions by an online system user within a threshold distance a particular physical location. The one or more specified actions and one or more particular locations may be specified in an ad request provided to the online system or may be associated with an ad request by the online system. A user, such as an advertiser, providing an ad request to the online system 140 may include one or more specific actions and physical locations associated with the specific actions in the ad request to identify conversions associated with an ad request. Alternatively or additionally, another user may identify one or more specific actions and physical locations associated with the specific actions along with an identifier of an ad request to the online system 140, which associates the specific actions and physical locations with the ad request to identify conversions associated with the ad request. Specific actions and associated physical locations may also be associated with content items other than ad requests by the online system 140.

Physical locations associated with a content item or an ad request may correspond to retail locations or other entities associated with the content item or the ad request, or associated with a user associated with the content item or the ad request. For example, a physical location corresponds to a location for purchasing a product or service associated with an advertisement or with another content item presented to various online system users via the online system 140. Example conversions include: a location of a user being within a threshold distance of a specified physical location, a user performing a financial transaction at a particular physical location, a user requesting information about a product, a service, or a user associated with an ad request or with a content item while the user's location is within a threshold distance of a particular physical location, or any other suitable action while a location associated with a user is within a threshold distance of a particular physical location. Hence, the online system 140 determines whether a user performed a conversion by determining whether location information associated with the user is within a threshold distance of a particular location and whether the user performed one or more specific actions associated with the particular location.

In one embodiment, the online system 140 identifies a conversion when the online system 140 receives 310 location information from a client device 110 associated with a user indicating the user is within a threshold distance of a physical location of a physical store associated with a content item presented by the online system 140. For example, the online system 140 identifies a conversion when location information received 310 by the online system 140 from a client device 110 associated with the user identifies a physical location within a threshold distance of a particular physical location associated with a content item. Additionally, the online system 140 may identify a conversion when the online system 140 receives 310 location information from a third party system 130 identifying a particular location associated with a content item and identifying an online system user in association with the particular location. For example, the online system 140 identifies a conversion when the online system 140 receives 310 location information identifying a physical location of a retail store associated with an advertisement and a user identifier from a point of sale terminal (e.g., a credit card reader) at the retail store.

Based on the identified conversions, the online system 140 determines 325 a number of conversions associated with users in the group and determines 330 a number of conversions associated with users in the alternative group. In some embodiments, the online system 140 determines 325, 330 a number of conversions associated with users in the group 410 and users in the alternative group 415 occurring within a particular time interval (e.g., within a week of a current time, within a month of the current time). When determining 325, 330 number of conversions associated with users in the group and associated with additional groups, the online system 140 may determine 325, 330 numbers of conversions by unique users in the group or in the additional group. For example, the online system 140 determines a number of unique users who performed a conversion event, so a single conversion event is identified for a user associated with a location within a threshold distance of a particular location associated with a content item multiple times within a particular time interval, allowing the online system to determine 325, 330 a number of conversions by unique users in the group and by unique users in the alternative group. Alternatively, the online system 140 determines 325, 330 a total number of conversions associated with users in the group and associated with users in the additional group. For example, a conversion is determined 325 each time a user in the alternative group is associated with location information within a threshold distance of a particular location associated with a content item (e.g., an ad request), so the online system 140 may determine 325, 330 a total number of conversions by users in the group and by users in the alternative group that identifies multiple conversions performed by a single user in the group or in the alternative group. In the example of FIG. 4A, the online system 140 determines 325 a number 421 of conversions associated with the group 410, also determines 330 a number 422 of conversions associated with the alternative group 415, and also determines a number 423 of conversions associated with the additional alternative group 420. In embodiments where the online system 140 identifies one or more subgroups in the group and alternative group, the online system 140 may determine a number of conversions associated with one or more of the subgroups (e.g., with each of the subgroups).

Based on the number of conversions associated with the group, the online system 140 determines 335 a value associated with the group. In some embodiments, the value is the number of conversions associated with the group. For example, referring to FIG. 4A, the number 421 of conversions associated with the group 410 is 306, so the value associated with the group 410 is 306 in some embodiments. In other embodiments, the online system 140 determines 335 the value associated with the group as a conversion rate of the group, which is a ratio of a number of conversions associated with the group to a number of users (or a number of unique users) in the group. For example in FIG. 4A, the conversion rate 425 of 0.08% is determined 335 as the value associated with the group 410. Alternatively, the value associated with the group is a number or a percentage of users of the group associated with one or more conversions. In other embodiments, the value associated with the group is a number of users in a subgroup of the group or a percentage of users in a subgroup of the group associated with one or more conversions. For example, the value is a percentage of conversions associated with a particular subgroup of the group, such as a subgroup including users presented with a particular content item by the online system.

In embodiments where the online system 140 identifies one or more subgroups of the group, the online system may determine values associated with different subgroups of the group (e.g., with each subgroup of the group). In some embodiments, a value associated with a subgroup of the group is a number of conversions or associated with the subgroup of the group or a percentage of conversions associated with the subgroup of the group. Alternatively, the value associated with a subgroup of the group is based on a conversion rate associated with the subgroup of the group.

Similarly, the online system 140 determines 340 an additional value associated with the alternative group based on the number of conversions associated with the alternative group. As described above, the additional value may be a number of conversions associated with the alternative group, a conversion rate of the alternative group (i.e., a ratio of a number of conversions associated with the alternative group to a total number of users in the alternative group), a percentage of conversions associated with the alternative group, a percentage of conversions associated with a subgroup of the alternative group, a number of conversions associated with a subgroup of the alternative group, a conversion rate of a subgroup of the alternative group, or any other suitable quantity. For example, in FIG. 4A, the number 422 of conversions associated with the alternative group 415 is the additional value determined 340 for the alternative group 415. As another example, a conversion rate 426 of the alternative group 415 is the additional value determined 340 for the alternative group 415. In embodiments where the online system 140 identifies one or more subgroups in the alternative group, the online system 140 may determine additional values associated with different subgroups of the alternative group (e.g., each subgroup of the alternative group).

Similarly, if the online system 140 identifies one or more additional alternative groups, the online system 140 may determine additional values associated with various additional alternative groups. For example, the online system 140 determines an additional value associated with each additional alternative group, as described above. In the example of FIG. 4A, the online system 140 determines an additional alternative value associated with the additional alternative group 420 as a number 423 of conversions associated with the additional alternative group 420 as a conversion rate 427 of the additional alternative group 420. Additional values may similarly be determined for various subgroups of different additional alternative groups.

Based on the number of users in the group, the number of users in the alternative group, conversions associated with the group, and conversions associated with the alternative group, the online system 140 computes 345 a scaling factor for modifying the additional value associated with the alternative group. In various embodiments, the scaling factor is based at least in part on a conversion rate of the group and a conversion rate of the alternative group. As described above, the conversion rate of the group is a ratio of the number of conversions associated with the group to the number of users in the group; similarly, the conversion rate of the alternative group is a ratio of the number of conversions associated with the alternative group to a number of users in the alternative group. In the example of FIG. 4A, the online system 140 computes a conversion rate 421 of 0.080% associated with the group 410 based on a ratio of 306 conversions to 380,865 users in the group 410. Similarly, the online system 140 computes a conversion rate 426 of 0.018% associated with the alternative group 415 based on a ratio of 348 conversions to 1,970,083 users in the alternative group 415 in the example of FIG. 4A. In other embodiments, the online system 140 determines a conversion rate associated with the group as a ratio of a number of conversions associated with the group to a number of times the online system 140 presented a particular content item to users in the group during a specific time interval, and similarly determines a conversion rate associated with the alternative group as a ratio of a number of conversions associated with the alternative group to a number of times the online system 140 presented a particular content item to users in the alternative group during the specific time interval.

In some embodiments, the online system 140 computes 345 the scaling factor as a ratio of the conversion rate associated with the group to the conversion rate associated with the alternative group. In the example of FIG. 4A, the online system 140 computes 345 the scaling factor by dividing the conversion rate 425 of 0.08% associated with the group 410 by the conversion rate 426 of 0.018% associated with the alternative group 415, resulting in a scaling factor of 4.44. In some embodiments, the online system 140 computes 345 the scaling factor based on conversion rates associated with one or more subgroups of the group and one or more subgroups of the alternative group or based on scaling factors associated with one or more subgroups of the group and associated with one or more subgroups of the alternative group. For example, the online system computes 345 a scaling factor for different subgroups of the alternative group (e.g., for each subgroup of the alternative group), with a scaling factor for a subgroup of the alternative group computed 345 as a ratio of a conversion rate associated with a corresponding subgroup of the group to a conversion rate of the subgroup of the alternative group. In some embodiments, the online system 140 computes 345 the scaling factor based on the scaling factors for subgroups of the alternative group. For example, the online system 140 computes 345 the scaling factor as a mean of the scaling factors for each subgroup of the alternative group or for multiple subgroups of the alternative group.

In the example of FIG. 4B, the online system 140 computes 345 scaling factors 430 for each subgroup 405 of the alternative group 415 shown in FIG. 4A based on conversion rates 425 associated with each subgroup 405 of the group 410 and conversion rates 426 associated with each corresponding subgroup 405 of the alternative group 415. For purposes of illustration, the scaling factors for different subgroups 405 shown in FIG. 4B are computed 345 by dividing a conversion rate 425 for a subgroup 405 of the group 410 by a conversion rate 426 for a corresponding subgroup 405 of the alternative group 415. In FIG. 4B, the scaling factor 440 is then determined as a mean of the scaling factors 420 for each subgroup 405 of the alternative group 415.

The scaling factor may also be based on a frequency with which the online system 140 receives 310 location information from client devices 110 associated with users in the group 410 and receives 310 location information from client devices 110 associated with users in the alternative group 415. In one embodiment, the scaling factor is calculated 345 as a ratio of a rate at which the online system 140 receives 310 location information from client devices 110 associated with users in the group 410 to a rate at which the online system 140 receives 310 location information from client devices 110 associated with users in the alternative group 415. For example, if the online system 140 receives 310 location information from client devices 110 associated with users in the group 410 at an average rate of eighty five percent of the time client devices 110 associated with users in the group 410 are connected to a network 120 coupled to the online system 140 and receives 310 location information from client devices 110 associated with users in the alternative group 415 at an average rate of seventeen percent of the time client devices 110 associated with users in the alternative group 415 are connected to a network 120 coupled to the online system 140, the online system 140 computes 345 a scaling factor of 85/17, or five.

In various embodiments, the online system 140 also computes one or more additional scaling factors associated one or more additional alternative groups. For example, in FIG. 4B, the online system 140 computes individual scaling factors 430 for each subgroup 405 of an additional alternative group 420 by dividing a conversion rate 425 associated with a subgroup 405 of the group 410 by a conversion rate 427 associated with a corresponding subgroup 405 of the additional alternative group 420 and calculates the scaling factor 440 associated with the additional alternative group 420 as a mean of the scaling factors 430 for the subgroups 405 of the additional group 420. In FIG. 4B, the mean of the scaling factors 430 for the subgroups 405 of the additional alternative group 420 results in a scaling factor 440 of 45 associated with the additional alternative group 420.

The online system 140 applies 350 the scaling factor to the additional value associated with the alternative group to generate a scaled additional value, which provides a measure of conversions associated with the alternative group 415 that accounts for potential conversions that were not identified by the online system 140 because the online system 140 receives 310 location information from client devices 110 associated with users in the alternative group at less than the threshold rate. For example, the scaled additional value provides an estimated number of conversions associated with the alternative group accounting for a potential number of conversions that were not identified by the online system 140 because location information was received 310 from client devices 110 associated with users in the alternative group at less than the threshold rate. As another example, the scaled additional value provides an estimated rate of conversions associated with the alternative group accounting for potential conversions that were not identified by the online system 140 because location information was received 310 from client devices 110 associated with users in the alternative group at less than the threshold rate.

In some embodiments, an estimated rate of conversions determined from scaling 350 the additional value by the scaling factor approximates the conversion rate associated with the group. For example, the online system 140 multiplies an additional value associated with the alternative group by the scaling factor, resulting in a scaled additional value that is an estimated number of conversions associated with the alternative group corresponding to a rate of conversion approximating the conversion rate associated with the group. Referring to FIG. 4C, the online system 140 applies 350 a scaling factor 440 associated with the alternative group 415 to the number of conversions 422 to the number of conversions associated with the alternative group 415, which generates a scaled number of conversions 450 associated with the alternative group 415. The scaled number of conversions 450 provides an estimated number of conversions associated with the alternative group that accounts for conversions that potentially occurred but were not identified by the online system 140 because of the rate at which the online system 140 received 310 location information from client devices 110 associated with users in the alternative group 415. Similarly, the online system 140 may apply a scaling factor 440 associated with an additional alternative group 420 to a number of conversions 423 associated with the additional alternative group 420 to generate a scaled number of conversions 460 associated with the additional alternative group 420.

Alternatively, the online system 140 applies 350 conversion factors associated with different subgroups of the alternative group to numbers conversions associated with the different subgroups to generate scaled numbers of conversions associated with different subgroups of the alternative group. The online system 140 may then combine scaled numbers of conversions associated with a combination of subgroups of the alternative group to generate a scaled number of conversions associated with the alternative group or may select a scaled number of conversions associated with a subgroup of the alternative group as a number of conversions associated with the alternative group. Referring to FIG. 4D, the online system 140 multiplies the number of conversions associated with different subgroups 405 of the additional group 415 by the scaling factors 430 corresponding to each of the subgroups 405, generating a scaled number of conversions for different subgroups 405 of the additional group 415. The online system 140 combines the scaled number of conversions for the different subgroups 405 of the additional group 415 to generate a scaled number of conversions associated with the alternative group 415; for example, the online system 140 sums the scaled number of conversions for the different subgroups 405 of the alternative group to generate the scaled number of conversions 470 associated with the alternative group. In various embodiments, the online system 140 may combine scaled numbers of conversions for certain combinations of subgroups 405 of the additional group 415 to generate the scaled number of conversions associated with the alternative group 415; alternatively, the online system 140 combines scaled numbers of conversions for each subgroup 405 of the additional group 415 to generate the scaled number of conversions associated with the alternative group 415. Similarly, the online system 140 may scale numbers of conversions associated with different subgroups 405 of an additional alternative group 420 by scaling factors 430 corresponding to each of the subgroups 405 of the additional alternative group 420 and combining the scaled number of conversions associated with the subgroups 405 of the additional alternative group to generate a scaled number of conversions 480 associated with the additional alternative group.

Based on the value associated with the group and scaled additional value associated with the alternative group, the online system 140 generates 355 a metric describing effectiveness of one or more content items presented by the online system 140 in inciting actions by online system users. Content items described by the metric may be advertisements, content items for which the online system 140 does not receive compensation for presenting, or various combinations of advertisements and other content items. As described above, an ad request including an advertisement or a content item may be associated with one or more specific actions, with one or more particular locations associated with various specific actions to identify a conversion event. The online system 140 may generate 355 the metric in response to receiving a request from a user who provided one or more content items to the online system 140 that identifies at least one content item; in some embodiments, the request may identify a particular type of conversion to use when generating 355 the metric.

In various embodiments, the online system 140 generates 355 the metric based on the identified number of conversions associated with the group and the estimated number of conversions associated with the alternative group determined from applying 350 the scaling factor to the additional value associated with the alternative group. For example, if the value associated with the group is a number of conversions associated with the group and the scaled additional value is an estimated number of conversions associated with the alternative group, the online system generates 355 the metric by adding, or by otherwise combining, the value and the scaled additional value. In some embodiments, the metric is also based at least in part on one or more other values associated with one or more additional alternative groups. In the example of FIG. 4C, the online system 410 generates 355 the metric by combining the value associated with group 410, the scaled additional value associated with the alternative group 415, and another scaled additional value associated with the additional alternative group 420 to generate 355 the metric, which identifies a total number of conversions associated with presenting an advertisement via the online system. The generated metric includes conversions identified by the online system 140 and also accounts for potential conversions that may not have been identified by the online system 140 because of different rates at which the online system 140 received 310 location information from different client devices 110.

In various embodiments, the online system 140 generates 355 the metric describing effectiveness of a content item in inciting user actions based on values associated with one or more particular subgroups of the group 410 and scaled additional values associated with one or more corresponding subgroups of the alternative group. For example, the online system 140 generates 355 the metric by combining a value associated with a subgroup of the group with a scaled additional value associated with a corresponding subgroup of the alternative group that includes users having one or more common characteristics as users in the subgroup associated with the group. For example, the online system 140 adds an identified number of conversions associated with a subgroup of the group and an estimated number of conversions associated with a corresponding subgroup of the alternative group to generate 355 a metric describing a content item's effectiveness at causing users having common characteristics as users in the subgroup of the group and as users in the subgroup of the alternative group. In the example of FIG. 4C, the online system 140 identifies four subgroups 405 of users associated with the group 410 and alternative group 415 that share a threshold number or percentage of characteristics. In this example, the online system 140 may combine the value (i.e., an identified number of conversions) associated with the a subgroup 405 of the group 410 and the scaled additional value (i.e., an estimated number of conversions) associated with a subgroup 405 of the alternative group 415 having the same common characteristics as the subgroup 405 of the group to generate 355 a metric describing a number of conversions associated with presenting an advertisement to users having the common characteristics of the subgroup 405 of the group 410 and the subgroup 405 of the alternative group 415.

In various embodiments, the metric generated 355 by the online system 140 is based on a difference between values associated with one or more subgroups of the group and one or more scaled additional values associated with the alternative group. For example, the online system 140 combines numbers of conversions associated with users in subgroups of the group that include users presented with an advertisement and scaled numbers of conversions associated with users in subgroups of the alternative group that include users presented with the advertisement (i.e., a test group of users) and combines numbers of conversions associated with users in subgroups of the group that include users not presented with the advertisement and scaled numbers of conversions associated with users in subgroups of the alternative group that include users not presented with the advertisement (i.e., a control group of users). The online system then generates 355 the metric as a difference between the combined number of conversions associated with users in subgroups of the group that include users presented with an advertisement with the scaled numbers of conversions associated with users in subgroups of the alternative group that include users presented with the advertisement and the combined number of conversions associated with users in subgroups of the group that include users not presented with the advertisement with the scaled numbers of conversions associated with users in subgroups of the alternative group that include users not presented with the advertisement. The determined difference identifies a number of conversions attributable to presenting the advertisement on the online system 140. Hence, in various embodiments, the generated metric describes effectiveness of a content item at inducing various groups and subgroups of users to perform certain actions after being presented with the content item on the online system 140 based on location data received 310 by the online system 140 at different rates from different client devices 110.

While FIGS. 3-4D describe embodiments where location information is received by the online system 140 at different rates from different client devices 110. In other embodiments, the method described above in conjunction with FIG. 3 may be used with other information received by the online system 140 at different rates from different devices. For example, the method described above in conjunction with FIG. 3 may be applied to transaction data (e.g., credit card transaction) provided to the online system 140 by various terminals. As another example, the method described above in conjunction with FIG. 3 may be applied to subscriptions for services identified to the online system 140, as the online system 140 may be unable to identify a user corresponding to each identified subscription.

### Summary

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, at an online system, location information describing one or more physical locations of a plurality of users of the online system, the location information describing a physical location of a user received from a client device associated with the user;
identifying a group of users associated with client devices from which the online system receives location information at greater than a threshold frequency;
identifying an alternative group of users associated with client devices from which the online system receives location information at less than the threshold frequency;
determining a number of occurrences of an event based at least in part on location information received from client devices associated with users in the group of users;
detecting an additional number of occurrences of the event based at least in part on location information received from client devices associated with users in the alternative group;
calculating a value associated with the group based at least in part on the number of occurrences of the event based at least in part on location information received from client devices associated with users in the group;
calculating an additional value associated with the alternative group based at least in part on the number of occurrences of the event based at least in part on location information received from client devices associated with users in the alternative group;
computing a scaling factor based at least in part on a number of users in the group, a number of users in the alternative group, the number of occurrences of the event based at least in part on location information received from client devices associated with users in the group, and the number of occurrences of the event based at least in part on location information received from client devices associated with users in the alternative group;
generating a scaled additional value by applying the scaling factor to the additional value; and
generating a metric describing an occurrence of the event based at least in part on the value and the scaled additional value.

2. The method of claim 1, wherein the plurality of users of the online system comprise users eligible to receive an advertisement via the online system.

3. The method of claim 1, wherein a physical location comprises a physical location for purchasing a product or service associated with an advertisement presented to one or more users of the online system.

4. The method of claim 1, wherein the event comprises a physical location of the user being within a threshold distance of a specified physical location.

5. The method of claim 4, wherein the specified physical location is a physical location associated with a content item presented to one or more users of the online system.

6. The method of claim 5, wherein the content item presented to the one or more users of the online system is an advertisement.

7. The method of claim 1, wherein the event comprises a financial transaction performed at one or more of the physical locations.

8. The method of claim 1, wherein the value associated with the group is selected from a group consisting of: a number of occurrences of the events, a rate of occurrences of the events, and a percentage of occurrences of the one or more events.

9. The method of claim 1, wherein the scaling factor is further based at least in part on a frequency at which the online system receives location information from client devices associated with users in the additional group.

10. The method of claim 1, wherein generating the metric describing the occurrence of the event comprises:
calculating a sum of the value associated with the group and the scaled additional value associated with the alternative group; and
generating the metric based at least in part on the sum.

11. The method of claim 1, wherein the group and the alternative group each include one or more subgroups.

12. The method of claim 1, wherein the group includes a subgroup of users each presented with an advertisement and a control subgroup of users who were not presented with the advertisement, and wherein the alternative group includes an additional subgroup of users each presented with the advertisement and an additional control subgroup of users who were not presented with the advertisement.

13. The method of claim 12, wherein generating the metric describing the occurrence of the event comprises:
calculating a sum of a value associated with the subgroup based at least in part on a number of occurrences of the event by users included in the subgroup and a value associated with the additional subgroup based at least in part on a number of occurrences of the event by users included in the additional subgroup and the scaling factor;
calculating an additional sum of a value associated with the control subgroup based at least in part on a number of occurrences of the event by users included in the control subgroup and a value associated with the additional control subgroup based at least in part on a number of occurrences of the event by users included in the additional control subgroup and the scaling factor; and
generating the metric based at least in part on a difference between the sum and the additional sum.

14. A method comprising:
receiving, at an online system, location information describing one or more physical locations of a plurality of users of the online system, the location information describing a physical location of a user received from a client device associated with the user;
identifying a group of users associated with client devices from which the online system receives location information at greater than a threshold frequency;
identifying an alternative group of users associated with client devices from which the online system receives location information at less than the threshold frequency;
determining a number of occurrences of an event based at least in part on location information received from client devices associated with users in the group of users;
detecting an additional number of occurrences of the event based at least in part on location information received from client devices associated with users in the alternative group;
calculating a value associated with the group based at least in part on the number of occurrences of the event based at least in part on location information received from client devices associated with users in the group;
calculating an additional value associated with the alternative group based at least in part on the number of occurrences of the event based at least in part on location information received from client devices associated with users in the alternative group and a scaling factor based at least in part on a number of users in the group, a number of users in the alternative group, the number of occurrences of the event based at least in part on location information received from client devices associated with users in the group, and the number of occurrences of the event based at least in part on location information received from client devices associated with users in the alternative group; and
generating a metric describing occurrence of the event based at least in part on the value and the additional value.

15. The method of claim 14, wherein a physical location comprises a physical location for purchasing a product or service associated with an advertisement presented to one or more users of the online system.

16. The method of claim 14, wherein the event comprises a physical location of the user being within a threshold distance of a specified physical location.

17. The method of claim 16, wherein the specified physical location is a physical location associated with a content item presented to one or more users of the online system.

18. The method of claim 14, wherein the event comprises a financial transaction at one or more of the physical locations.

19. The method of claim 14, wherein the value associated with the group is selected from a group consisting of: a number of occurrences of the events, a rate of occurrences of the events, and a percentage of occurrences of the one or more events.

20. The method of claim 14, wherein the scaling factor is further based at least in part on a frequency at which the online system receives location information from client devices associated with users in the additional group.

21. The method of claim 14, wherein the group includes a subgroup of users each presented with an advertisement and a control subgroup of users who were not presented with the advertisement, and wherein the alternative group includes an additional subgroup of users each presented with the advertisement and an additional control subgroup of users who were not presented with the advertisement.

22. The method of claim 14, wherein generating the metric describing the occurrence of the event comprises:
calculating a sum of a value associated with the subgroup based at least in part on a number of occurrences of the event by users included in the subgroup and a value associated with the additional subgroup based at least in part on a number of occurrences of the event by users included in the additional subgroup and the scaling factor;
calculating an additional sum of a value associated with the control subgroup based at least in part on a number of occurrences of the event by users included in the control subgroup and a value associated with the additional control subgroup based at least in part on a number of occurrences of the event by users included in the additional control subgroup and the scaling factor; and
generating the metric based at least in part on a difference between the sum and the additional sum.

23. A computer program product comprising a computer readable storage medium having instructions encoded thereon that, when executed by a processor, cause the processor to:
receive, at an online system, location information describing one or more physical locations of a plurality of users of the online system, the location information describing a physical location of a user received from a client device associated with the user;
identify a group of users associated with client devices from which the online system receives location information at greater than a threshold frequency;
identify an alternative group of users associated with client devices from which the online system receives location information at less than the threshold frequency;
determine a number of occurrences of an event based at least in part on location information received from client devices associated with users in the group of users;
detect an additional number of occurrences of the event based at least in part on location information received from client devices associated with users in the alternative group;
calculate a value associated with the group based at least in part on the number of occurrences of the event based at least in part on location information received from client devices associated with users in the group;
calculate an additional value associated with the alternative group based at least in part on the number of occurrences of the event based at least in part on location information received from client devices associated with users in the alternative group;
compute a scaling factor based at least in part on a number of users in the group, a number of users in the alternative group, the number of occurrences of the event based at least in part on location information received from client devices associated with users in the group, and the number of occurrences of the event based at least in part on location information received from client devices associated with users in the alternative group;
generate a scaled additional value by applying the scaling factor to the additional value; and
generate a metric describing an occurrence of the event based at least in part on the value and the scaled additional value.
